(19) United States
(12) Patent Application Publication
(10) Pub. No.: US 2014/0230711 A1
(43) Pub. Date: Aug. 21, 2014

(54) Mobile Operations Chassis with Controlled Magnetic Attraction to Ferrous Surfaces

(71) Applicant: SeaRobotics Corporation, Stuart, FL (US)

(72) Inventors: Reginald Benjamin Lovelace, Stuart, FL (US); Donald T. Darling, Palm Beach Gardens, FL (US); Kenneth W. Holappa, Naples, FL (US)

(73) Assignee: SeaRobotics Corporation, Stuart, FL (US)

(21) Appl. No.: 14/194,003

(22) Filed: Feb. 28, 2014

Related U.S. Application Data
(63) Continuation-in-part of application No. 13/950,700, filed on Jul. 25, 2013, now abandoned.
Application No. 13/950,700 is a division of application No. 12/952,973, filed on Nov. 23, 2010, now Pat. No. 8,506,719.
(60) Provisional application No. 61/263,680, filed on Nov. 23, 2009.
(60) Provisional application No. 61/773,941, filed on Mar. 7, 2013.

(51) Int. Cl. B63B 59/08; B62D 63/04

(52) U.S. Cl. CPC B63B 59/08; B62D 63/04
USPC 114/222; 280/781; 180/9.1; 180/54.1; 180/20

(57) ABSTRACT

A chassis clings to a ship hull or other ferrous surface by a magnet that moves toward or away from the surface to adjust the magnet air gap and thus the attractive force. The magnet(s) can be the only clinging force or used with other sources such as a suction chamber or fluid jet drive. An internal magnet on a crank mechanism can pivot around a wheel rotation axis inside a wheel body having a non-ferrous traction surface or tire. The magnet gap is least at an angle perpendicular to the surface on which the wheel rests, and larger at an angle oblique to that, for varying the attractive force to two or more levels. The vehicle can be an autonomous hull maintenance device with sensors, controllers and actuators to sense, measure and clean away fouling.

### CROSS-REFERENCE TO RELATED APPLICATIONS

This application is a Continuation in Part of pending application Ser. No. 13/950,700, filed Jul. 25, 2013, and also claims the benefit of pending U.S. Provisional Patent Application Ser. No. 61/773,941, filed Mar. 7, 2013. application Ser. No. 13/950,700 is a division of application Ser. No. 12/952,973, filed Nov. 23, 2010, now U.S. Pat. No. 8,506,719, and claims the benefit of U.S. Provisional Patent Application No. 61/263,680, filed on Nov. 23, 2009. The foregoing applications in their entireties are each hereby incorporated by reference into the present disclosure.

### BACKGROUND OF THE INVENTION

The invention concerns the field of apparatus that exert force relative to a supporting structure, for example to cling to the structure against the force of gravity or while applying a tool or a fluid jet or other force against the structure, or to provide traction for wheels or tracks that enable the apparatus to move along a surface of the structure. The surface of the structure might be horizontal or inclined or vertical. If horizontal, the surface could be the underside of a structure to which the apparatus is to cling.

Techniques are known for providing an air flow or water flow directed away from the apparatus in a direction away from such a surface, for causing the apparatus to cling using a reactive force. According to embodiments of the invention disclosed herein, an apparatus preferably provides by an attractive force pulling the apparatus toward the structure. Such force can be exerted by an electromagnet or a permanent magnet, causing a tool bearing or mobile chassis of an apparatus to cling to a ferrous surface. A practical example is an underwater de-fouling apparatus to be maneuvered over the surface of the hull of a ship.

A magnet and a ferrous mass (or another magnet) form a magnetic circuit along lines of magnetic flux. The magnetically permeable magnet and ferrous mass confine the lines of flux. Where there is a zone of non-permeable or less permeable material in the magnetic flux circuit, typically an empty gap, a physical force arises. The force might be attractive or repulsive depending on magnetic polarity, but for purposes of this disclosure can be assumed to refer to a force of magnetic attraction. The magnetic attraction may cause an apparatus to cling to a ferrous structure across a gap, or at a point of contact, between a flux concentrating part of the apparatus and a ferrous magnetically permeable part of the structure. In the case of structures that are non-ferrous or thin or otherwise not magnetically permeable, an apparatus may cling to such structures due to attraction to a magnet carried on the opposite side of the structure in a manner that allows the magnet to be moved along by the magnet on the other side.

The magnetic force seeks to pull closed the gap in the magnetically permeable pathway, which can be arranged to be a force of attraction for clinging. The gap may be an air gap (namely gap that is unoccupied except by air or perhaps water). The gap may be wholly or partly occupied by a magnetically non-permeable or relatively non-permeable material. In the present disclosure, the gap is occupied in part, in some situations, by magnetically non-permeable solid or flexible material that rests against the surface of a ferrous or permeable material, such as a tire, track or traction belt. The attraction producing space in the magnetically permeable path of a magnetic circuit is termed a “gap” or an “air gap” or a “distance” in this disclosure, referring to the aspect that attractive force is provided by electromagnetic forces that seek to conserve flux density to the most permeable path of least magnetic resistance, which generally means a force to reduce or close that space.

The force of magnetic attraction between elements of a magnetic flux circuit as described varies with the amplitude of magnetic flux and with the distance between flux confining ferrous or otherwise magnetically permeable materials. The force is the greatest when the gap is smallest. As a practical matter, the inverse relationship of the force of attraction versus the length of the gap, causes a permanent magnet that is movable into proximity with a ferrous structure to tend to snatch into contact with the ferrous structure. Direct contact at maximum available attractive force might be useful in some scenarios, such as when an apparatus is to remain fixed and stationary on a ferrous surface or when it is advantageous to exert a maximum clinging force, such as to resist external forces or when crawling out of the water. But such contact is not always desirable with enabling an apparatus to be moved over a surface to which the apparatus clings, preferably clinging robustly but enabling the apparatus to be moved without undue friction. On the other hand, the maximum force exerted by a magnet relative to a ferrous body is obtained at the minimum air gap. It would be advantageous to take efficient advantage of the maximum available force by minimizing the air gap when needed, but not to have the magnet engage directly, and in a manner that enables control of the force exerted.

One might control the magnetic flux amplitude to adjust the attractive force exerted by an electromagnet placed near a ferrous body, by varying the current amplitude in a conductive coil. This has the advantage of allowing the attractive force to be adjusted or turned off, but is more complicated that using a permanent magnet. What is needed is a controllable way hold a minimum air gap distance.

The subject matter of the invention is particularly applicable to remotely operated or semi-autonomous mobile apparatus for traversing ship hulls. In one arrangement, a hull traversing carriage is configured to cling to a hull and equipped with sensor and actuators. The apparatus is programmed to assess fouling conditions and to schedule and carry out ongoing de-fouling operations.

### SUMMARY OF THE INVENTION

The present invention benefits moving platforms and moving vehicles or similar mobile mechanisms that require intermittent attachment to and/or application of clinging force toward a steel or ferrous surface. In one form, the inventive apparatus comprises one or more permanent magnets or electro magnets mounted and arranged in a magnetic configuration with an gap relative to a ferrous surface to which the apparatus is attracted. One or more magnets can be mounted under, behind or beside the moving object, or coupled into a magnetic flux circuit bridging a gap at such locations.

In one embodiment, the gap is associated with a moving drive element having a surface that is urged against the ferrous surface, such as a wheel, disk or track. A controllable mechanism permits the magnet force to be varied by changing the size of the gap, e.g., using a linkage that moves a magnet configuration toward and away from the ferrous surface to facilitate or reduce (or eliminate) clinging force by changing the gap distance. The linkage can support the configuration and selected ones of multiple gap distances, for example including a large gap at which the magnetic force is small, near or direct contact at which the magnetic force is large and the magnet may hold the vehicle stationary, and intermediate gaps at which the attractive force is more or less.

In the case of a disclosed linkage that is angularly positioned relative to a wheel rotation axis, the linkage also can be used to change the direction of high magnetic attraction, as opposed to changing its amplitude in the direction normal to the supporting surface. Changing the direction may be useful when motivating a vehicle through a corner or bump. For example, by placing the wheel at the leading edge of the moving object and arranging to angularly swing the magnet forward to 90 degrees when encountering a surface perpendicular to the surface presently being traversed (namely by bringing the magnet close to the perpendicular surface), the force of attraction is shifted over the perpendicular surface, enabling the moving object to climb onto and to proceed along the perpendicular surface while clinging.

Clinging surface-traversing devices are useful, for example, to carry tool actuators for brushes or sanders or scrapers or other apparatus that exert operational force against the steel or ferrous surface that the devices traverse. The operational force on the tool may exceed the force of gravity holding the device against a substantially horizontal surface, tending to push the device away from the surface. The surface to be processed may be steeply inclined, vertical, horizontal-inverted or inclined on an underside, presenting additional challenge. On such surfaces, gravity may not only fail to resist the force of applying tools to the surface, but even worse, gravity may tend to detach the vehicle from the surface regardless of tool force or may urge the vehicle along the surface when displacement is not desired. Clinging forces are useful on inclined and inverted surfaces that a vehicle is designed to run along, as well as on horizontal surfaces where gravity does not provide sufficient normal force for traction or to oppose an operational tool.

Surfaces to be worked might be vertical, horizontal, inclined or inverted. Ferrous surfaces can be located in various environments, including under water. Ship hulls are apt surfaces where an attractive wheeled apparatus or traction device can be useful. Apart from the outer surfaces of movable structures such as ship hulls, stationary structures might be worked, and on inner surfaces as well as outer ones, such as steel pipes and water tanks among others.

A traction drive mechanism is an example where two bodies are engaged for movement relative to one another and engage with some amount of force, e.g., at wheels or tracks. Familiar vehicles such as bicycles and automobiles rely on the weight of the vehicle to exert force on the roadway via the tires, sufficient to produce friction preventing slippage and allowing the vehicle to advance laterally along the road surface as the wheels are forced to rotate. A floor polisher is a structurally different example having a moving disk or wheel that rests against the floor and requires force (from mass and gravity) to apply operational force against the horizontal floor. When the road or floor is inclined, the vertical force of gravity becomes less effective to apply force in a direction perpendicular to the surface, according to the cosine of the angle of incline. At high angles or on vertical surfaces or inverted surfaces, gravity is counterproductive to the task at hand, which requires pressure against the surface.

A variety of mechanisms may be useful to assist with cleaning, inspection or other work on horizontal, low angle, flat and/or curved surfaces, and are supported and moved in different ways. A wheeled trolley or cart might support and move equipment to a work location. For activities that require a stationary platform, brakes on the wheels may be sufficient to hold the trolley or cart. This approach is less effective and becomes unworkable as the angle of incline increases relative to horizontal or for inverted surfaces.

A trolley or cart might be secured in other ways for attachment to non-horizontal surfaces, but not as conveniently as by applying brakes that are made effective by gravity when on horizontal or low sloping surfaces. Clamps, tie downs and ropes require an anchoring place to which one may tie or clamp. Vertical working surfaces are common, and may require a platform or carriage suspended from an anchoring place at the top of a structure, such in the case of window washing platforms. Similar platforms are used inside or outside water towers, tanks and ship hulls. Suspended platforms are not typically outfitted to produce force in the direction of the working surface (e.g., the ship hull) and additionally require a movable vertical positioning drive. Restraint in a direction toward such a surface may accomplished by conveniently located ropes or cables, perhaps assisted with counterweights, suction devices, fans and blowers. In an underwater application, propeller driven thrusters can be used to press a vehicle into contact with a rigid surface that is steeply inclined or even inverted. But in these and other situations, if the working surface is ferrous, magnetic force is an attractive alternative.

Magnets are useful to provide an attracting force normal to a ferrous structure regardless of surface orientation. A magnet touching the surface of the ferrous structure (with no air gap) provides the highest force obtainable from the magnet. When using a U (horseshoe) or bar magnet with opposite polarities applied to the ferrous surface, magnetic flux is channeled efficiently through the materials of highest magnetic permeability (the magnet and the ferrous structure). Once attached, releasing the magnet can be an issue.

Magnets can be mounted on the surfaces of wheels or tracks that directly contact the surface. As the wheel rotates or the track moves, magnets alternately attach and detach as the wheel or track turns, moving the vehicle or apparatus across the surface. By definition some magnets are in contact with the ferrous surface and some are not. Generally, more magnets are not in contact compared to the ones that are. For round wheels, only one or two magnets on the wheel circumference might be close enough to provide useful attraction at a given time. The magnets around the wheel circumference, spaced from the ferrous surface, are dead weight and added cost.

Magnets can be located on the chassis of the moving device instead of on wheels, tracks or runners. The magnets can arranged along a magnetically permeable path that does not contact the ferrous surface but rides over it at a minimal air gap to provide for good attraction, but the gap needs to be sufficient to provide clearance for the magnetic elements to pass over any obstructions such as those encountered when traversing an irregular, fouled or corroded surface.

Magnets have been mounted to traction wheels as well as mounted directly to the vehicle chassis so as to extend to near the attracting surface. Magnets can be compromised if other steel parts are attracted to the magnet and interrupt a clear flux path between magnet and attracting surface at the nominal gap needed. These magnets and also those on rotating wheels are subject to contamination if loose ferrous steel or rust particles exist in the environment. Loose ferrous particles are attracted to the magnet and accumulate. Over a period of time the buildup can be excessive and reduce the effectiveness of the traction drive or detract from the magnetic flux path that provides an attractive force dependent on a small nominal gap.

According to certain embodiments, the ferrous surface to be worked or traversed can be regarded as stationary. The movable vehicle carriage or chassis comprises one or more cylinders with an axis parallel to the ferrous surface, acting as one or more of a wheel, roller, pulley sheave or track supporting roller. If the cylinder contacts the ferrous surface, the cylinder can act as a drive wheel that motivates the vehicle or carriage or alternatively as a supporting or steering element. The outer radius of the cylinder resides on or near the ferrous surface during operation. A magnet associated with the cylinder or wheel applies an attractive force in a direction normal to the ferrous surface being acted upon.

The magnet may be mounted behind a movable surface in contact with the ferrous surface and associated with the wheel, such as a moving surface including a tire with or without tread, a belt or a track that develops friction when pressed into contact with the ferrous surface. The friction producing material is preferably not magnetically permeable and is relatively thin, so as to maximize available magnetic force by minimizing the dimensions of the gap in the magnetic circuit. In such an embodiment, the magnet can be mounted inside the wheel structure, such as behind the tread of a tire at the outer radius of the wheel. The magnet structure can be mounted on bearings that allow the wheel to turn relative to the magnet, whereas the magnet depends to the most magnetically attractive geometric position, for example turning on the wheel axis in a direction to maximize attractive force.

In one embodiment, a magnet mounted in association with a wheel is restrained by a lever or similar mechanism apart from the rotating wheel. The mechanism maintains the magnet in a fixed position orienting attractive force along a line normal to the ferrous surface when the magnetic attraction is at its maximum or fully engaged state. The mechanism can also retract the magnet relative to the ferrous attracting surface to reduce the attractive force in a state where the magnet is partially engaged. With sufficient retraction, the attractive force is reduced to a trivial amount and the magnet is essentially in an off position. The lever or other mechanism can be actuated manually, electrically via a motor or solenoid, pneumatically or hydraulically with a linear or rotary actuator. In one embodiment, the mechanism pivots the magnet relative to the wheel rotation axis, the fully engaged position orienting the magnet normal to the attractive ferrous surface at minimum gap, and the gap being made larger by pivoting the magnet mounting to the front or rear, thus lifting the magnet around an angular span and raising the magnet from the attractive surface.

In an alternative embodiment, a plurality of magnets are mounted relative to wheel rotation axis, preferably inside the wheel, in one or more pairs that can be angularly displaced toward and away from one another, as well as toward and away from an angle of magnetic clinging attraction, normally normal to the supporting surface. When the paired magnets are moved together so as to abut along the angle normal to the surface, the clinging force is greatest. When the paired magnets are rotated away from one another and angularly displaced from the angle normal to the supporting surface, one clockwise and one counterclockwise, the magnetic force is reduced.

Similarly, plural magnets can be stacked in an axial direction within a wheel or along an axis parallel to the supporting surface but other than the wheel rotation axis. A mechanism preferably allows all or a subset of the plural magnets to be directed normal to the vehicle supporting surface at a reduced or minimum gap, as well to an angle that is angularly displaced from normal, and thereby spaced from the supporting surface to a greater than minimum gap according to the geometry of the angle.

Advantageously, a belt engages with two or more wheels or sheaves to provide a traction or bulldozer track type of drive that moves the vehicle or carriage. In this embodiment, the belt is preferably thin and the magnet is mounted behind the belt. Magnets can be provided in association with each wheel or between the wheels and arranged behind the thin belt. Depending on magnet strength and location the belt can be arranged to be compressed against the ferrous surface by magnetic force in those areas where the magnet is located. To minimize friction between the belt and the magnet or magnet supporting structure, one or more rollers can be integrated into the mechanism to maintain a minimal but nonzero separation between the belt and magnet, in which case the separation and the belt contribute to the so-called gap (including air, water and any non-magnetic materials between the magnet and the surface. The magnet presses the traction or track drive against the ferrous surface. The belt engages the ferrous surface with the attachment force running thought the belt, any rollers, the mounting frame of the magnet and ending at the magnet. Magnetic force can be varied by mechanically varying the distance between magnet and attracting surface, for example by angularly positioning magnets or paired sets of magnets as described above. This can be accomplished with a linkage mechanism that is actuated manually, electrically via a motor or solenoid, pneumatically or hydraulically with a linear or rotary actuator.

In alternative embodiments, a moving surface associated with a magnet can comprise a cylindrical shape or disk with an axis normal to the ferrous surface or mounted at an oblique angle. The moving surface can be a sanding, grinding, brushing or buffing disk that interacts with and applies friction to the ferrous surface. Magnets supply the attractive force necessary to make the sanding or brushing disk bear effectively against the ferrous surface. Such magnets can be mounted beside or behind the brush. If mounted behind the brush, the thickness of the brush or its carrier is advantageously small to maintain a small gap in the state of maximum magnetic attraction. The attractive force can variable as described using a mechanism to increase the gap. This can be accomplished with a linkage mechanism that is actuated manually, electrically via a motor or solenoid, pneumatically or hydraulically with a linear or rotary actuator.

### BRIEF DESCRIPTION OF THE DRAWINGS

There are shown in the drawings certain examples and embodiments discussed in connection with explaining concepts of the invention. It should be understood that the invention is not limited to the embodiments shown as examples. In the drawings:

FIGS. 1a through 1e show a variety of applications of hull structure traversing vehicles with magnetic wheels;

FIG. 2 is a perspective view of a magnetic wheel assembly;

FIG. 3 is a cross section of the wheel showing certain parts;

FIG. 4 is a perspective rear view of the wheel showing a driving gear;

FIGS. 5a and 5b are elevations showing an operational attractive position and a retracted release position of a magnet activation mechanism, respectively;

FIG. 6 is an perspective illustration of a two wheel arrangement with a mechanism for operating two wheel magnets in tandem;

FIG. 7 shows an alternate or additional embodiment as compared to FIG. 6, including a drive track or belt carried on two wheels or rollers.

FIG. 8 shows the system components of one example of a HullBUG cleaning system.

FIG. 9 illustrates the HullBUG cleaning system with a wireless link to a controller.

FIG. 10 illustrates one example of a HullBUG cleaning system configured with a tether management system.

FIG. 11 illustrates one example of a HullBUG cleaning system with a stationary magnetic attachment.

FIG. 12 illustrates one example of a HullBUG cleaning system with magnetic wheels.

FIG. 13 illustrates one example of a HullBUG cleaning system configured with negative pressure device.

FIG. 14 illustrates one example of a HullBUG cleaning system configured with a propulsion system that includes thrusters.

FIG. 15 illustrates one example of a HullBUG cleaning system configured with a propulsion system that includes rubber wheels.

FIG. 16 illustrates one example of a HullBUG cleaning system configured with a propulsion system that includes a track system.

FIG. 17 illustrates one example of a HullBUG cleaning system with a cleaning mechanism that includes a vertical axis brush cleaner.

FIG. 18 illustrates one example of a HullBUG cleaning system with a cleaning mechanism that includes a horizontal squeegee cleaner.

FIG. 19 illustrates one example of a HullBUG cleaning system having a device in the form of a plurality of jets.

FIG. 20 illustrates one example of a HullBUG cleaning system with biofilm sensor array.

FIG. 21 illustrates one example of a HullBUG cleaning system configured with optical flow sensors.

FIG. 22 illustrates one example of a HullBUG cleaning system configured with a pressure sensor for depth measurement.

FIG. 23 is a flow chart comprising two corresponding connected figures shown as 23a and 23b, illustrating one example of a cleaning mission using a depth sensor that may be performed by the HullBUG cleaning system.

FIG. 24 illustrates one example of a HullBUG cleaning system configured with a structured laser light sensor.

FIG. 25 illustrates one example of a HullBUG cleaning system configured with an array of flex sensors.

FIG. 26 illustrates one example of a HullBUG cleaning system configured with a Miniature Acoustic Ranging Sonar (MARS).

FIG. 27 is a flow chart comprising two corresponding connected figures shown as 27a and 27b illustrating one example of a method of sensing performed by the HullBUG cleaning system illustrated in FIG. 26.

FIG. 28 illustrates one example of a HullBUG cleaning system configured with an imaging or bathymetric SONAR.

FIG. 29 is a flow chart of controller using SONAR and a biofilm sensor.

FIG. 30 illustrates a HullBUG cleaning system and its associated replenishment station.

FIG. 31 is a block diagram of one example of a controller for controlling the HullBUG cleaning device.

FIG. 32 is a schematic illustration in a sequence of steps shown in four parts (FIGS. 32a through 32d) showing a technique for traversing a right angle while applying attractive force.

### DETAILED DESCRIPTION OF EXEMPLARY EMBODIMENTS

A structure with controlled magnetic attraction to ferrous surfaces as disclosed herein is advantageously applied to vehicles arranged to maneuver over surfaces such as steel ship hulls, tank walls, bridges, bulwarks and similar ferrous structures in order to inspect and to apply tools to such surfaces. Exemplary embodiments include underwater semi-autonomous vehicles for inspecting ship hull surfaces using cameras and sensors, for applying tools such as brushes and scrapers for de-fouling, etc. In certain embodiments, the vehicles are equipped with magnetic attraction aspects for clinging to ferrous structures during operation and while traversing surfaces. According to other aspects, the vehicles carry particular tools and serve particular functions enabling programmed operations such as assessment of fouling, fouling rates and scheduling to control fouling.

Cleaning, inspection and tool bearing vehicles or mechanisms are advantageously configured to climb steel surfaces such as dry land water towers, radio towers, transmission line columns, bridges, building frames, and marine structures or vessels such as oil platforms and ships. Such vehicles conventionally can be held by force of gravity atop surfaces that are more or less horizontal. It is an aspect of this disclosure to enable vehicles and devices to cling to sloping surfaces, vertical wall surfaces or the undersides of horizontal surface or sloping inverted surfaces, using attractive or surface-directed force. Some attractive forces include suction, negative pressure, magnetic attraction or other mechanical means.

One object is to produce attractive force sufficient to move and hold the vehicle or device against the structure, i.e., to direct a vector of vehicle driving thrust or to provide a supplemental source of force oriented to force the vehicle toward the surface. Another object is to apply sufficient force to enable the application of tools and surface traversing drive arrangements that need attractive force to produce traction. A further object is to maximize the attractive or clinging force of which the device is capable, and another object is to enable the extent of attractive force to be controlled, namely controllable applied at less than its maximum amplitude. In order to meet these and other objects, the present developments provide attractive force for ferrous structures using one or more magnets, preferably permanent magnets. The amplitude of the attraction is adjustable by mechanically varying the gap in a magnetic circuit including the magnet and the ferrous surface.

In exemplary embodiments as described, a permanent magnet is arranged on a mechanism to pivot around the rotation axis of a wheel or track roller of a drive configuration. Pivoting is driven by mechanical linkages or by similar positioning techniques, to an angle at which the magnet is oriented substantially directly and perpendicularly toward the surface over which the vehicle is movable on the wheel or track. This angle provides a minimum air gap and a maximum force of attraction. The concept of an “air gap” as used herein refers to a gap in a magnetic circuit, and includes gaps that are occupied by nonferrous material as well as gaps that may be occupied by air alone. The linkage also is configured controllably to pivot the magnet or magnet mechanism angularly away from an angle perpendicular to the surface to one or more retracted or semi-retracted positions at which the air gap distance is larger and the magnetic force is less. In some embodiments, the dimension of the wheel or roller and the force of the magnet are arranged such that at least one retracted position provides an air gap large enough to render any remaining attraction trivial, essentially releasing the vehicle from clinging to the ferrous surface.

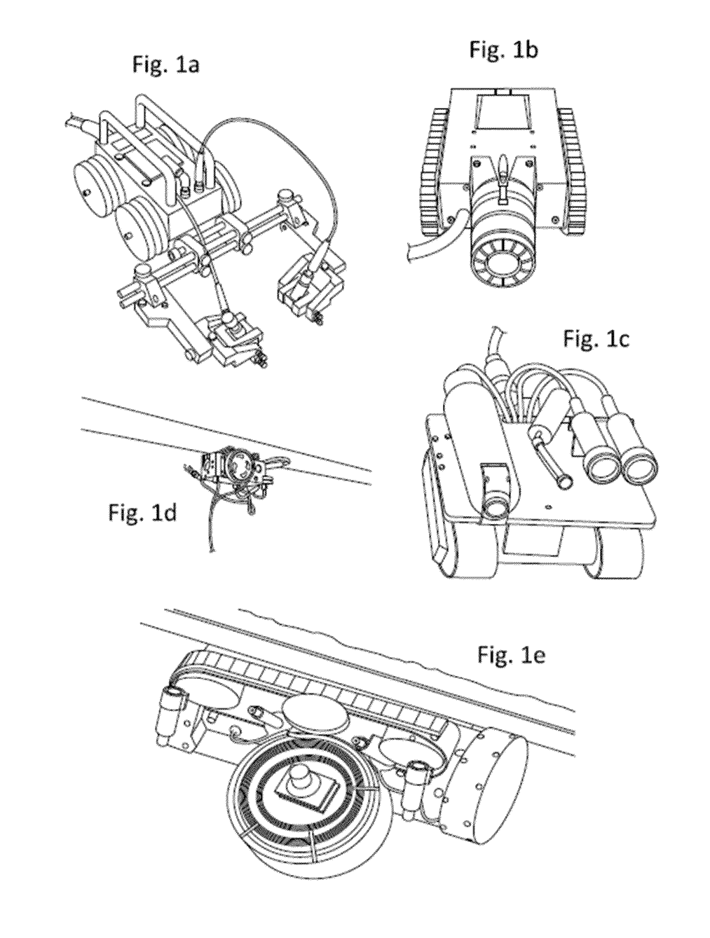

Mechanisms as described may operate above or below the water on land, sea or air, and can be mechanically driven via wheels, or belts or tracks coupled to motors or the like, to traverse the surfaces to which they cling. FIGS. 1a-1e illustrate a number of examples, in this case showing the HullBUG submersible vehicle of applicant, SeaRobotics Corporation, disclosed in U.S. patent application Ser. No. 12/952,973, filed Nov. 23, 2010, which has been incorporated herein by reference.

For operating wheels, tools or other apparatus provided on the vehicle, the vehicle is brought into close proximity or into contact with the surface of interest. If one or more electromagnets are used for attraction, they are powered with current. If one or more permanent magnets are provided on linkages as discussed herein, they are brought into close proximity with the attracting surface. The linkages enable the magnets or controllable parts of their magnetically permeable associated structures such as flux concentrators, to be moved to “on” and “off” positions, or more preferably, between a “full on” position, one or more “intermediate on” positions, and a substantially retracted “off” position, via manually or electromagnetically actuated operators.

The magnets employed are sized and provided in numbers sufficient to allow the vehicle or apparatus to cling and hold its position or a ferrous surface, or to move over the surface if a traversing drive capability is provided. If movement along the attracting ferrous surface is desired, the vehicle is rolled into position by driving elements using a motor driving a wheel or track, in by less complicated driving elements such as a rope or cable pulling the vehicle, a fluid jet propulsion drive or another such device. The vehicle or cart can be continuously moved or driven during work operation or can be moved to a fixed location and secured at that location. After work operations are complete the vehicle is moved to a recovery point and the magnets are moved to the “off” position. Once in the “off” position the vehicle or cart can be safely removed from the ferrous surface.

An advantage of permanent magnet attraction is that when the magnet linkage sets the magnet into its attracting position, no power is required to maintain the clinging force. Available power can be devoted to other uses including operation of sensors and tools, surface maneuvering, etc., rather than using power for producing fluid suction in a negative pressure area or electromagnets to maintain clinging attachment to the hull. A permanent magnet clinging arrangement may use solenoid or motor power to move the magnet arrangement to the “off” or “on” position but preferably that is provided using a configuration that is stable in the on or off position without application of power. Examples are bistable linkages, push-on/push-off mechanisms, self locking lead screws. etc.

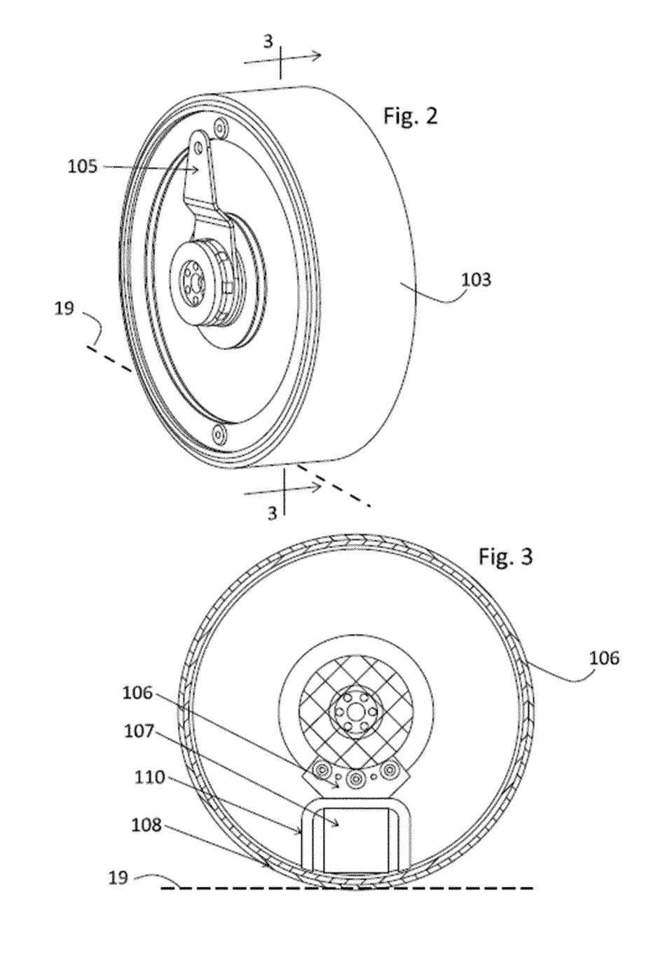

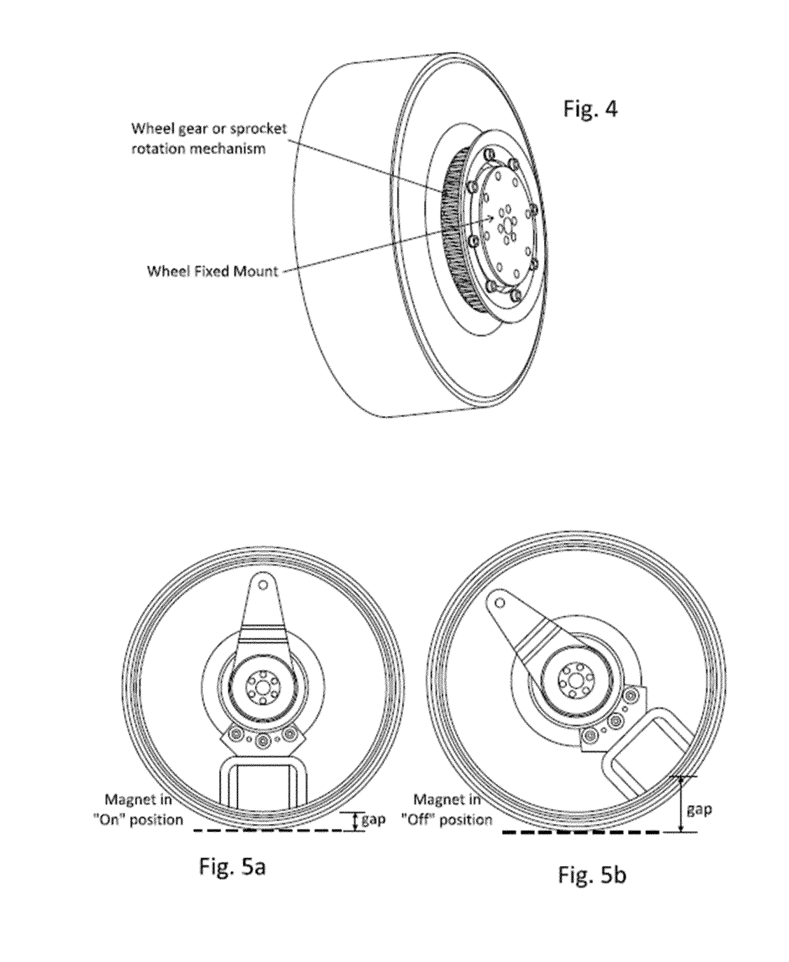

Referring to FIGS. 2 and 3, an exemplary embodiment of the invention comprises an assembly of a movable permanent magnet arranged internally in a wheel 103. The wheel 103 may be a drive wheel, idle wheel or steering mechanism standing perpendicularly on the ferrous attractive surface 19 with the wheel axis parallel to the attractive surface. The wheel can work independently from others, or be connected to another wheel via gears or a belt. The operation of the magnet assembly in the wheel is independent of the rotation of the wheel but preferably is concentrically arranged with the axle of the wheel. As shown in FIG. 4, the bearing structures of the wheel apart from the magnet assembly can be driven by other mechanisms, a gear or sprocket being shown for coupling to a chain, or belt, etc.

In FIGS. 2 and 3, a crank arm 105 is mechanically connected to a mounting structure 106 inside the wheel. The mounting structure carries a permanent magnet 107. The magnet 107 is fixed at the radial outside of the space inside the wheel behind the wheel surface, which can comprise a tire-like friction material 108 where the wheel is to bear directly against surface 19. The mounting structure 106 is configured such that rotating crank 105 rotates the mounting structure 106 inside the wheel. In one angular position of the crank 105, the mounting structure and the magnet are oriented directed downwardly toward the attractive surface 19, as shown in FIG. 3. In this position, the gap between magnet 107 and surface 19 is at a minimum distance and the magnetic attraction is at a maximum. By moving the crank and connected mounting structure angularly away from the position shown in FIG. 3, the gap between the magnet 107 and the surface 19 becomes greater and the force of attraction is reduced.

The permanent magnet 107 is shown with a flux concentrator 110 wrapping around the magnet. A flux concentrator is an appropriately shaped piece of magnetically permeable material which is placed to be included in the magnetic flux circuit, shown in the example as wrapped over the magnet, and concentrates the flux density.

See FIGS. 5a, 5b schematically compare the magnet positions for a typical single wheel with a permanent magnet configuration position via the external lever arm for actuating the magnet attraction “on” (FIG. 5a) or at least partly “off” (FIG. 5b) due to the larger air gap provided when the mounting for the magnet 107 is at an angle. The face part of the wheel is not shown so as to show the relationship of the magnet 107 and the crank 105. The thin layer on the outside of the wheel is a tire-like surface included for traction with the purposes. Although not necessarily to scale, these figures show that mechanical positioning of the magnet changes the level of magnetic attraction.

Preferably, the linkage is arranged to fix the magnet 107 at any of at least two and potentially several angular positions, the extreme positions being the “on” position of FIG. 5a and an “off” position. When the magnet is “on” the permanent magnet is in the position closest to the attracting surface. When the magnet is “off” the permanent magnet is in the position furthest away from the attracting surface. Intermediate positions provide intermediate attraction forces.

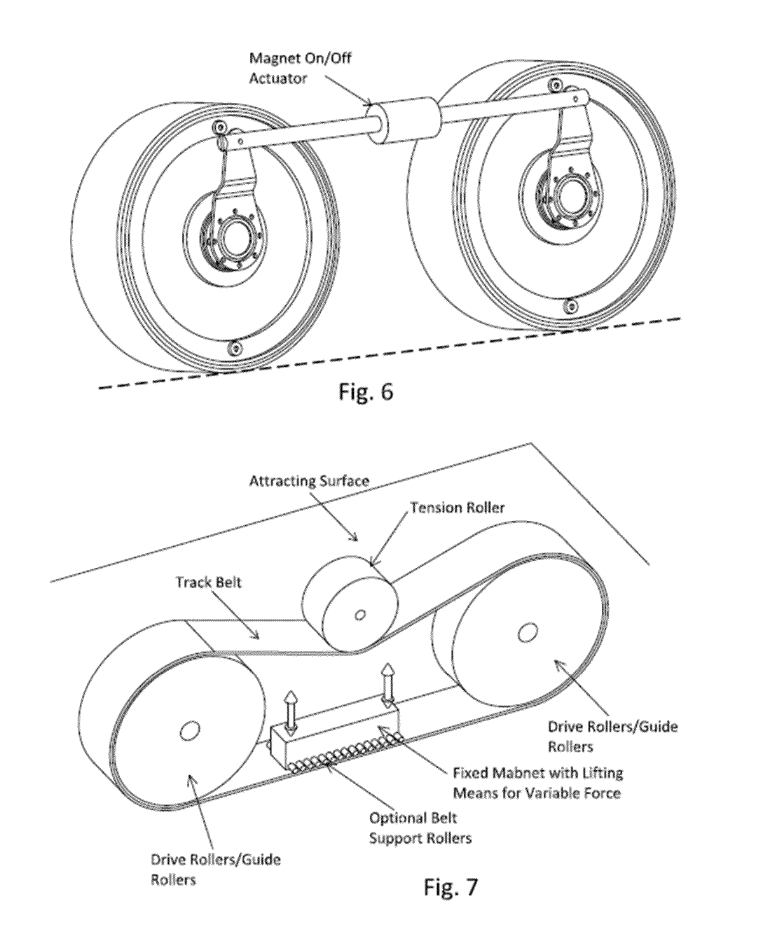

The magnet mounting mechanism is free to move between angular positions relative to the chassis (not shown in FIGS. 5a, 5b) as described. The remainder of the wheel including the tire assembly and any drive aspects as in FIG. 4 is free to move independently on the wheel axis. At least the rotating outer part of the wheel in contact with the surface 19 can be driven by application of torque through a gear, belt and pulley, chain and sprocket, rotatable axle or other provisions. Two or more magnet-equipped wheels can be operated in tandem as shown in FIG. 6. A belt and roller arrangement is shown in FIG. 7, wherein the belt provides the traction surface and a magnet is alternatively or additionally supported so as to roll on the belt from behind at a point between the roller wheels. The magnet between the roller wheels is likewise deployable against the belt at minimal air gap, to produce traction with the belt, or liftable by a mechanism (shown only schematically) to increase the air gap and release such traction.

An advantage of the disclosed embodiments is that all the attraction power of which one or more permanent magnets is capable can be deployed, moderated or switched off, requiring only the magnet mount and linkage to move the magnet, which is a savings of complexity, cost and weight compared to other clinging attraction or force directing alternatives.

According to another aspect, a load cell can be provided between the magnet and the fixed support to measure the extent of attraction being applied. In an embodiment wherein the attraction is controlled to various degrees, the attraction can be adjusted by controlled operation of the mechanism. Alternatively, insufficient attraction can be sensed to generate an alarm.

An advantage of the internal magnet concept as shown is that the wheel is self-cleaning as it revolves around the fixed magnet. Exposed magnets or magnets with a permanent flux emergence location on a tire or other intervening surface tend to attract and accumulate ferrous material, metal filings, etc., especially in an environment where a hull or the like is to be worked by scrapers or brushes that free ferrous metal power or flakes. According the disclosed arrangement, any free flakes or powder attracted to the enclosed magnet container formed by the wheel are carried away from the magnet by rotation of the wheel. In this way, accumulating material on the wheel or tire is not prone to accumulate and adversely affect the magnetic circuit in general or the gap in particular.

The disclosed controllably attractive magnetic wheel is tolerant of different environments. The inside of the wheel can be substantially sealed from external pressure and needs sufficient strength to withstand the pressure encountered in use. The closed container for the magnet can be oil filled and pressure compensated to the expected ambient pressure, which also helps to lubricate and protect the bearings and other parts.

In different embodiments, the magnetically attractive wheel device can be applied to self-powered vehicles or can be freewheeling, depending on the application. Drive motors and gearing if required to rotate one or more of the wheels of a chassis can be mounted internally in the wheel, out of the range of the magnet, or externally.

It is an aspect of the invention that a magnet is located inside a wheel with the wheel rotating around the magnet while stationary but for its angular adjustment for setting an minimal gap or one or more larger gaps achieved by maintaining the magnet at an angle normal to the supporting surface or at an angle displaced from normal. This technique usefully exploits substantially all the force available from the magnet when at the minimum gap and has the additional benefit of controllable attraction force. By way of contrast, a less desirable alternative magnetic wheel might have a number of permanent magnets angularly spaced around the periphery of a wheel. In such a case, only the magnets immediately adjacent or in contact with the surface are functional at a given time while the rest are useless weight. In rotating the wheel, the drive mechanism may need to exert energy to lift a leading magnet from the surface, depending on magnet spacing and the position of the next magnet approaching the surface on the opposite side.

The crank or lever arm used to rotate the magnet into and out of it its attractive operating position is readily dimensioned to provide the leverage needed to rotate the mounting arrangement and pull even a relatively strong magnet away from the attracting surface. Strong magnets can produce unwanted or excessive attraction effects near ferrous objects, for example unexpected clinging to a nearby ferrous surface. In manipulating a device, it is possible to have a hand or finger pinched between a wheel and an attractive surface. The magnet(s) may have enough force to move the vehicle or the apparatus unexpectedly when magnet and ferrous material are in close proximity. A hand, finger or other extremity can get between the magnet and attracting surface and be injured. The lever function allows the magnet to be rotated to the “off” position or to reduced attractive force when full attraction is not needed. If not needed for clinging attraction, the lower attraction force settings may also be beneficial to reduce the potential damage to paint or coatings that a strongly attracted vehicle may produce when wheeled around on a surface.

The lever that moves the magnet can be actuated manually or by some other externally controlled means via an electrically energized motor or solenoid, or by pneumatic or hydraulic linear or rotary actuator. Alternatively, actuating a linear movement of the magnet toward the wheel axle could be utilized to increase the gap with the actuator within the wheel.

Referring to FIG. 7, in an alternative to an internal-wheel magnet, a permanent magnet with a gap distance control can be is mounted behind a moving traction belt or track for causing a belt or track driven vehicle to cling to the ferrous surface that it traverses. The magnet shown in FIG. 7 can be exclusive or in addition to magnets inside the wheels as already described.

The belt drive of FIG. 7 also has a degree of associated self cleaning. Loose ferrous particles or debris that are attracted to the underside of the belt or to the magnet near the magnet are carried away with the motion of the belt. The belt tends to wipe the magnet where there is contact. By encasing the magnet in a nonferrous casing of substantial thickness, except on the side facing the belt, the tendency to accumulate debris is low and the attraction concentrated for efficient clinging attraction using a permanent magnet.

The mechanical linkages used for moving an internal wheel magnet as in FIGS. 5a, 5b, 6 or a belt pressure magnet as in FIG. 7, can be actuated manually or by some other externally controlled means via an electrically energized motor or solenoid, or by pneumatic or hydraulic linear or rotary actuator. If desired, a load cell or other load measuring device can be inserted in the load path to measure the actual force the magnet is applying to the belt or track system.

Magnetic attraction as disclosed is applicable to a horizontal disc application with a vertical rotation axis as well as a vertical standing wheel application with a horizontal rotation axis (in this case, horizontal denoting parallel to the attractive surface). The horizontal disk concept may involve, for example, a brush or sanding disc that spins horizontally relative to a horizontal surface, namely with a rotation axis normal to the surface. To be effective the disk needs a force applied normal to the disk in the direction of the attracting surface. If the attracting surface is made from ferrous material the force can be generated with magnets. The magnets can be mounted to the side of the rotating disk or behind it. If behind it the disk needs to be relatively thin to maximize available magnetic force.

As in other magnetic concepts loose ferrous particles can be attracted to fixed magnets and reduce the available holding power of the magnet. Loose particles can jam into mechanisms and cause other problems. When considering the horizontal disk concept, the magnets, if located behind the disk, should be segmented such that the magnetic field varies as the disk spins in the field. This varying of magnetic field allows the particles to lose their attractiveness and release their attachment for the brief period of time the particles magnetic field is reduced. During that time centrifugal force pushes the particle toward the outside diameter of the disk. With properly sized and placed magnets the pulsating field in concert with the spinning disk will eventually spin off the accumulating particles.

Alternately the magnets can be movable relative to the disk. As the magnets move some distance from the disk magnetic attraction reduces to zero. At that point all extraneous ferrous material on the disk would lose its attractiveness and fall off or could be cleaned off. Moving the magnet back in close proximity to the disk allows it to be operated again. Periodic movement of the magnet relative to the disk may be necessary to prevent unwanted buildup of loose ferrous particles.

The ability of the magnet to be moved to other than “full on” positions also allows the possibility of moving to intermediate positions. Potentially the magnet can be moved to an intermediate or modulating position to provide attractive force at some value between full “on” and “off”. This might be important where too much load on a brush or sanding disk could render its action less effective or potentially damaging. To lower the attracting force the magnet attachment system might be moved further away from the attracting surface than the “full on” position.

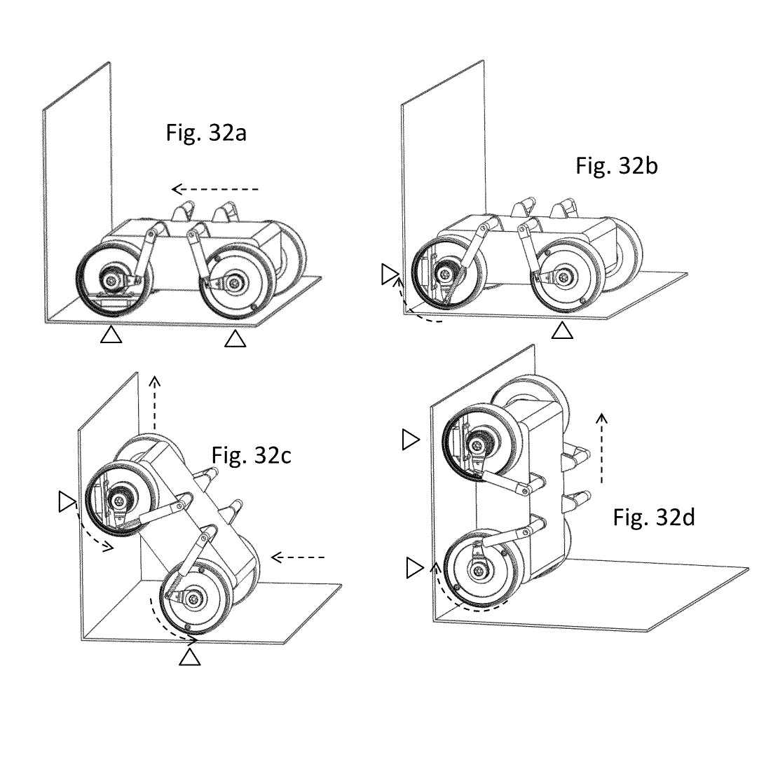

The variable positioning of magnets as described is useful in other situations besides clinging to a flat surface. For example, FIG. 32 comprises four FIGS. 32a through 32d, showing how the magnets described herein can be arranged to shift their attraction from one surface to another. In this embodiment, independently controllable movable magnets are provided in the front and rear wheels of a vehicle having its wheels are located at or near the extreme front and/or rear ends of the vehicle. The vehicle has encountered a barrier in the form of a perpendicular wall as shown in FIG. 32a, for example a vertical wall (although the orientation is not critical), while clinging to a surface, for example a horizontal surface. It is desired to continue to progress up onto the perpendicular wall.

In FIG. 32b, the magnets of the front wheels are rotated forward or counterclockwise, e.g., up to 90 degrees, thereby increasing the gap relative to the horizontal surface and decreasing the gap relative to the perpendicular wall. The front of the vehicle clings to the perpendicular wall. Magnets in the rear wheels (not shown in FIG. 32) continue to cling to the horizontal surface.

In FIG. 32c, the vehicle advances by driving the front and/or rear wheels to rotate relative to the vehicle and relative to the magnets. Preferably the wheels are driven to rotate while simultaneously rotating the front wheel magnet counterclockwise relative to the wheel axis, so as to keep the front wheel magnet at a minimum gap oriented toward the perpendicular wall. At the same time, assuming that a magnet is also provided in the rear wheel (not shown in FIG. 32), the rear wheel magnet is rotated counterclockwise relative to the vehicle to remain oriented toward and at a minimum gap with the horizontal surface. In this way, the vehicle clings to both the horizontal and vertical surfaces while traversing the right angle.

When the rear wheels encounter the vertical wall as in FIG. 32d, the rear wheel magnets are then rotated clockwise 90 degrees so as to cling to the vertical wall instead of the horizontal surface. At this point the vehicle clings exclusively to the vertical wall and can move away from the right angle (upwardly in the drawing). The foregoing sequence of magnet movements is one example of various sequences that may be employed to traverse an obstruction. In traversing the inside right angle as described, the sequence involves clinging to the adjacent surface while the vehicle rotates through the right angle.

In an alternative example, such as traversing an outside right angle (again assuming moving from an arbitrary horizontal surface over an edge to a vertical surface), it is possible to run the vehicle up to and slightly beyond the right angle edge while clinging to the surface horizontal surface, for example clinging with the magnets perpendicular to the horizontal plane supporting the vehicle chassis and wheels. This advance continues (preferably slowly) until the wheel rotation axis of the front wheels is at the edge of the right angle. The wheels are then driven to move the chassis forward while rotating the front wheel magnet rearward and the rear wheel magnet forward, e.g., up to 45 degrees. Rotation of the front wheel and the front wheel magnet can correspond. This releases the clinging attraction of the rear wheel by increasing the gap of the rear wheel magnet, and shifts the attraction of the front wheel to the vertical wall. The front wheel then continues to drive while clinging to the vertical wall. Simultaneously, the front wheel and rear wheel magnets are rotated to return from their angle (e.g., 45 degrees) relative to the plane defined by the vehicle chassis and wheels, back to the normal operational angle of 90 degrees relative to the plane of the chassis and wheels. This brings the chassis back to a position where the front and rear wheel magnets all cling to the vertical surface and the vehicle has crawled over the outside right angle edge.

The rotation of the magnets can be driven in various ways, a lever being shown as an exemplary mechanism that can be actuated manually and directly or indirectly through a simple linkage or by some other externally controlled means such as an electrically energized motor or solenoid, or by pneumatic or hydraulic linear or rotary actuators. If desired, a load cell or other load measuring device can be inserted in the load path to measure the actual force the magnet is applying to the horizontal disk.

A magnet associated with a moving traction surface such as a thin belt as in FIG. 7 can be employed as the only clinging mechanism, or in addition to a wheel magnet clinging mechanism as described. The magnet for the belt can be fixed or more preferably mounted at a controllably variable height above the attracting surface and behind the belt. The belt is urged against the ferrous attracting surface by pressure from the magnet on the back of the belt. The drive wheels pull the belt under the magnet and thereby benefit from the traction of the belt against the attracting surface. However, in this arrangement, the drive must be powerful enough to overcome friction between the back side of the belt and the magnet. Optional belt support rollers minimize friction between the magnet and the belt.

The clinging magnetic vehicle or chassis is usefully applied, for example, to an autonomous underwater wheeled robot for hull grooming. The device prevents the accumulation of marine fouling by traversing a ship hull underwater. Preferably, sensors detect the extent of fouling present. Actuators apply appropriate scrapers, brushes or other tools to detach the fouling (bio-film, barnacles, sea weed, etc.) from the hull. In some embodiments, negative pressure fluid flow alternatives can be used such that the device clings to the hull by suction. Alternatively or additionally a magnetic clinging devices is employed as described. A suite of onboard sensors not only detects fouling, but also provides inputs for obstacle avoidance, path planning and navigation.

By reducing marine fouling on ship hulls, the device improves ship performance by eliminating a source of drag and improving fuel efficiency. Rigorous or regular de-fouling operations also reduce the risk that species that attach to the hull when the ship is deployed at one location may be transported to another location and released as an unwanted invasive species. The present invention allows hull grooming to be carried on continuously by an autonomous robot that traverses the hull with little if any human attention required.

A cleaning system is disclosed that includes a chassis supporting a propulsion system for propelling the cleaning system across a surface. At least one sensor of a first type is coupled to the chassis, and a surface engagement mechanism is configured to maintain the cleaning system coupled to the surface as the propulsion system propels the cleaning system across the surface. A cleaning device is coupled to the chassis and configured to abrade the fouling from the surface, and a controller coupled to the chassis and in signal communication with the propulsion system and the first sensor. The controller is configured to receive a signal from the at least one sensor of the first type and control the propulsion system in response to the signal.

A clinging surface traversing apparatus as described (such as the SeaRobotics Corporation HullBUG) can be configured to be autonomous or remotely operated. Communications can be accomplished through a tether or with a wireless system. The tethered configuration and the wireless configuration allow the operator to view video feed back of the cleaning operation as it proceeds. The tethered configuration and the wireless configuration also allow the system to be used for real-time monitoring. In an autonomous configuration, a controller can be located inside or otherwise coupled to the chassis of the apparatus, while in the tethered and wireless configurations the controller may be on the apparatus or remotely located.

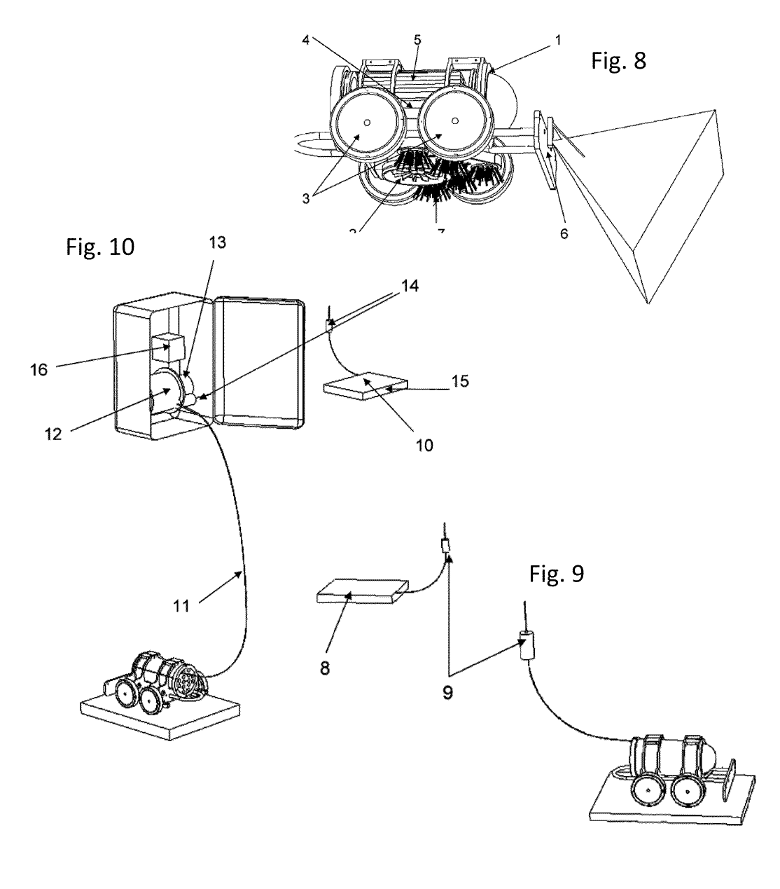

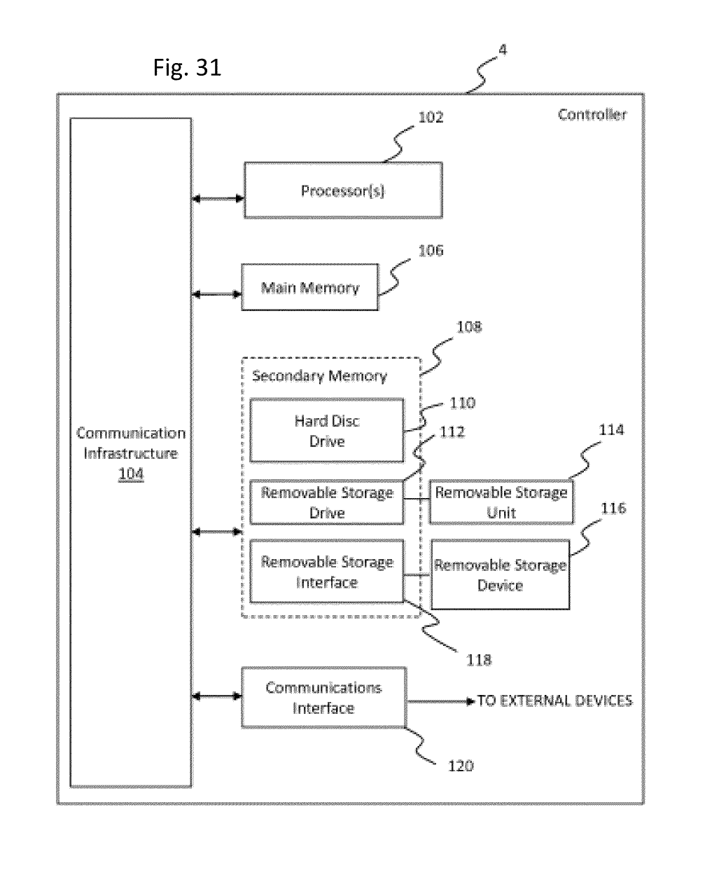

In one embodiment, a controller 4 is located inside or otherwise coupled to the chassis of the cleaning system as shown in FIG. 8 and allows for totally autonomous operation. One example of an architecture of controller 4 is illustrated in FIG. 31. Controller 4 may be a computer or other computing device or devices that may be configured to send and receive data and perform the functions described herein. As shown in FIG. 31, controller 4 may include one or more processors 102, which may be connected to a wired or wireless communication infrastructure 104 (e.g., a communications bus, cross-over bar, local area network (“LAN”), or wide area network (“WAN”)). Processor 102 may be any central processing unit, microprocessor, micro-controller, computational device, or like device. Processor(s) 104 may be configured to run one or more multitasking operating systems.

Controller 4 may include a main memory 106, such as a random access memory (“RAM”). Controller 4 may also include or be in communication with a secondary memory 108 such as, for example, a hard disk drive 110 and/or removable storage drive 112, representing a floppy disk drive, a magnetic tape drive, an optical disk drive, or the like. The removable storage drive 112 may read from and/or write to a removable storage unit 114. Removable storage unit 114 may be a floppy disk, magnetic tape, CD-ROM, DVD-ROM, optical disk, blu-ray disk, ZIP™ drive, and the like, which may be written to and/or read by removable storage drive 112. Removable storage unit 114 may include a machine readable storage medium having stored therein computer software and/or data.

In some embodiments, secondary memory 108 may include other similar devices for allowing computer programs or other instructions to be loaded into controller 4 such as a removable storage device 116 and a removable storage interface or socket 118. An example of such a removable storage device 116 and socket 118 includes, but is not limited to, a USB flash drive and associated USB port, respectively. Other removable storage devices 116 and interfaces 118 that allow software and data to be transferred from the removable storage device 116 to controller 4 may be used.

Controller 4 may also include a communications interface 120. Communications interface 120 allows software and data to be transferred between controller 4 and external devices, e.g., the sensors described below that provide data for aiding in navigation and biofouling detection. Examples of communications interface 120 may include a modem, a network interface (such as an Ethernet card), a wireless communication card, a communications port, a Personal Computer Memory Card International Association (PCMCIA) slot and card, or the like. Software and data transferred via communications interface 120 are in the form of signals which may be electronic, electromagnetic, optical, or any other signal capable of being received by communications interface 120. These signals are provided to communications interface 120 via a communications path or channel. The path or channel that carries the signals may be implemented using wire or cable, fiber optics, a telephone line, a cellular link, a radio frequency (“RF”) link, and the like.

In another embodiment a remotely coupled controller 8 is connected to the cleaning system through a wireless communication link 9 as shown in FIG. 9. In another embodiment a remotely coupled controller 10 is connected to the cleaning system through a tether 11 as shown in FIG. 10. In the tethered configuration the HullBUG is connected to the surface support station through a tether 11 to an operator interface system as shown in FIG. 9. This configuration may be used for development purposes and when operator feedback is desirable for inspection and or guidance purposes. The long tether cable is managed using a Tether Management System (“TMS”) 12. The TMS uses a slip-ring assembly 13 to allow for reeling the cable in and out. The TMS cable drum has a wireless communication system 14 for transferring commands to the TMS from the topside computer and then down the tether to the vehicle. Similarly the vehicle can send communications and video back up the tether, across the wireless link and to the topside computer 15 where it can be displayed. Power can be supplied to the cleaning system through the tether from a power supply 16 located within the TMS. This power supply can recharge the energy storage module located within the vehicle and it can power the vehicle for operation.

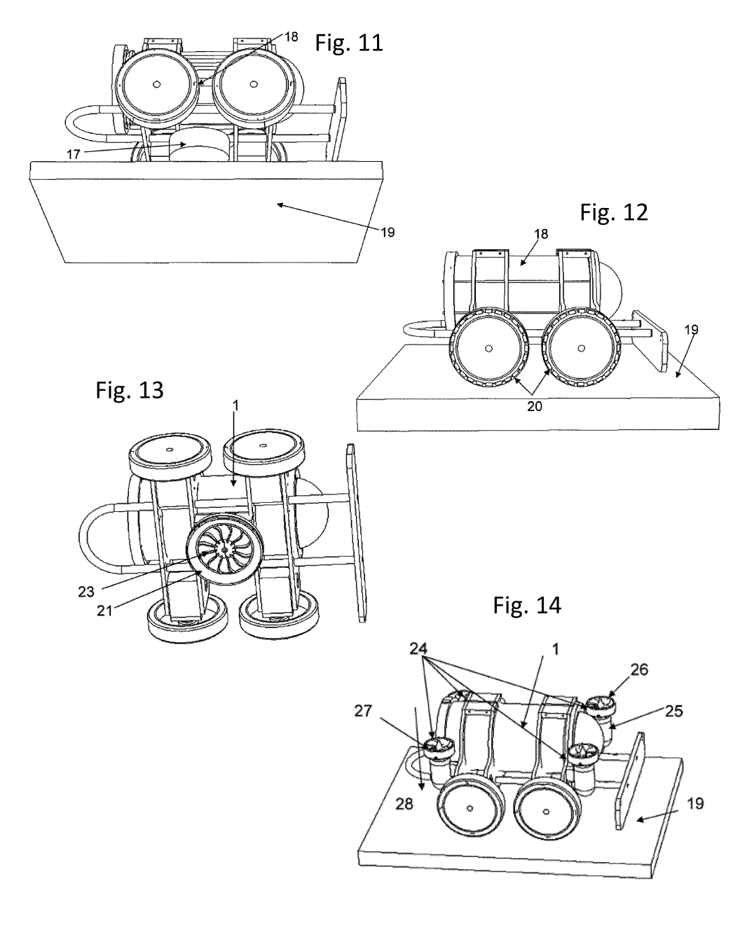

The cleaning system attaches to the underwater surface with a surface engagement mechanism, which may include magnetic attraction, negative pressure based attraction, or both. In one embodiment, the surface engagement mechanism includes one or more magnets 17 attached to the bottom of the chassis 18 as shown in FIG. 11. The magnets are sized to maximize the attractive force while minimizing the magnetic residual imparted into certain Navy hulls. The magnetic attraction force provides a passive method of holding the system to the hull allowing maximum endurance on a fixed energy supply when transiting over a ferrous metal substrate 19 that is within a prescribed proximity to the magnets.

In another embodiment the surface engagement mechanism includes a magnet or group of magnets integrated into the wheels 20 or tracks as shown in FIG. 12. A variety of magnetic arrangements are implemented including powerful ring magnets and more sophisticated multi-pole magnet arrangements. For example, the multi-pole magnet assemblies may include up to 24 pole pairs and generate a minimal residual magnetic signature. These magnet assemblies are further built into wheel assemblies and may be similar to the rotors used in permanent magnet brushless DC motors.

In another embodiment the HullBUG cleaning system utilizes a negative pressure mechanism 21 for attraction to the hull 19 shown in FIG. 13. This negative pressure source is comprised of a rotary mechanism 23, which provides an attractive force due to the dynamic motion of the fluid flow it generates. An example of such a negative pressure source is described in U.S. Pat. No. 5,194,032, which issued Mar. 16, 1993.

In another embodiment, the cleaning system attaches to the surface 19 through the use of thrusters 24 that accelerate the fluid from a first side of the thruster 25 to a second side of the thruster 26 as shown in FIG. 14. An example of such commercially available thruster is the Model HPDC 1509 available from SeaRobotix Inc. of San Diego Calif. One skilled in the art will understand that other thrusters for use on Remote Operated Vehicles and utilize propellers 27 to accelerate the fluid and provide an axial force 28 may be implemented. The negative pressure based attraction can be used when transiting over non-ferrous substrates as well as providing a beneficial relationship between attractive force standoff distance. The negative pressure mechanisms are more tolerance of standoff distance than the magnetic attractors.

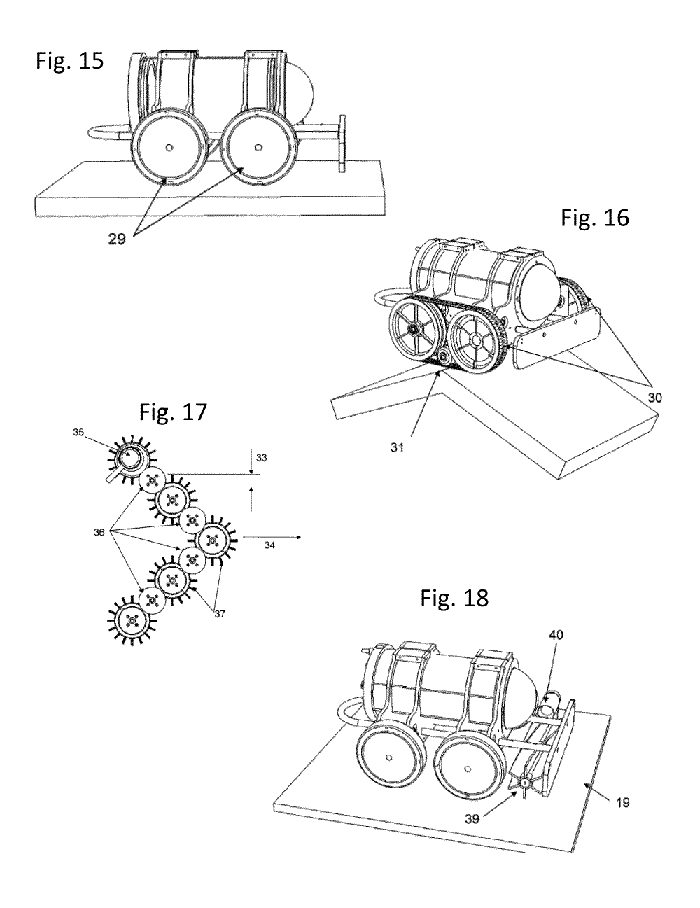

In one embodiment, the propulsion system includes one or more wheels 29 as shown in FIG. 15. As shown in FIG. 15, a set of four driven wheels can be implemented, although one skilled in the art will understand that fewer or more wheels may be used. The wheels 29 are driven in a tank like fashion to achieve maneuvering. This system offers excellent traction and maneuvering.

In another embodiment the propulsion system includes tracks 30 fitted to the drive system for use on hulls where crossing the angled intersection of relatively flat surfaces 31 is required such as a chine on the underwater surface of a ship and is shown in FIG. 16.

The cleaning system is configured with one or more cleaning devices for removing the biofilm from a surface, such as a surface of a hull of a boat. The system may include a sensor described below for measurement of the presence of biofilm and so the controller can control intensity of the cleaning action by controlling the speed of the cleaning device motor or pump as well as the applied pressure to the surface in response to the measured fouling level. In one embodiment, the cleaning device includes multiple vertical axis brushes 7 as shown in FIG. 15. As shown in FIG. 17, the rotary brushes are positioned so that there is overlap 33 of the cleaning action in the direction of forward motion 34. A motor 35 drives the brushes through a gear system 36 so that each brush spins about its respective central axis. The bristles 37 are positioned such that they are in contact with the surface of the ship 19 and remove any biofilm 38 (see FIG. 20) that may be on the surface.

In another embodiment, the cleaning mechanism utilized in the system can take the form of a forward rotating drum with horizontal axis of rotation, as shown in FIG. 18, such as the type of drum that is used in certain street sweepers. The cleaning device may also include one or more a rubber flaps or squeegees disposed on a horizontal axis 39 and driven by a motor 40.

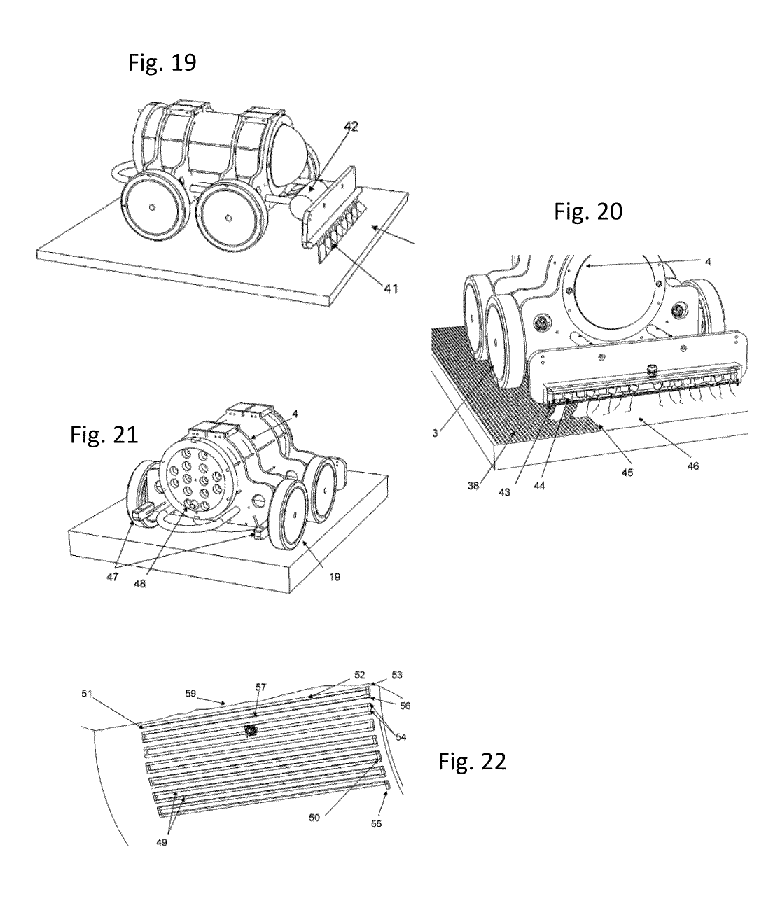

In another embodiment the cleaning system uses multiple jets 41 to remove the biofilm 38 (see FIG. 20) as shown in FIG. 19. Multiple jets are used so that each jet can be kept as close as possible to the surface to be cleaned 19 without hanging on obstacles. A minimum distance is desirable due to the loss of jet velocity as the jet passes through the ambient fluid. A small pump 42 is used to take in ambient fluid and create sufficient pressure to allow removal of the biofilm. The jets are angled forward slightly and may include an oscillation mechanism as is typically found on industrial pressure washers. The jets, like all of the cleaning mechanisms, can be turned on by the controller during those times that the measured level of biofilm fouling is above some threshold.

One or more sensors are communicatively coupled to controller and provide data and information to controller for navigating the cleaning system along the surface. A unique sensing system is incorporated that can detect and measure the fouling level on the surface of the hull. This sensing system can provide a quantitative measurement of the extent and intensity of the biofilm. The sensing system can also provide navigation information to the controller for cleaning optimization. The system includes one or more sensors to detect the interface between a recently cleaned hull section and a hull section exhibiting increased fouling because it is not yet cleaned. Data collected by the sensing system is provided to the controller, which is used in a navigation algorithm thereby allowing for optimized area coverage of the hull. The sensing system utilizes a set of light sources and light detectors to identify line of demarcation between the cleaned hull surface versus The fouled hull surface by measuring the relative level of chlorophyll-A present in the biofilm. The sensing system has been tested on a barely visible biofilm and was able to detect the difference between the clean surface and the unclean surface.

In one embodiment, the sensing system includes a silicon photo diode light detector 43 or array of light detectors that identify the level of chlorophyll present in a biofilm 38 due to phenomena know as fluorescence. Chlorophyll is an indicator of biofilm and therefore measuring the level of chlorophyll provides an indication of the level of fouling. Chlorophyll level can be measured using red light detectors 43 at a typical wavelength of 675 ηm by first illuminating the chlorophyll with a blue light emitting diode 44 at a typical wavelength of 480 ηm and then measuring the red light returned. One skilled in the art will understand that other wavelengths may be used.

An array of chlorophyll level measuring light detectors 43 enables the determination of the edge 45 separating the fouled area of the surface 38 and the unfouled or cleaned area of the underwater surface 46. This information is provided to controller 4 and utilized to guide the cleaning system while propelled along the underwater surface 19 by propulsion system 3.

In another embodiment, one or more optical flow sensors 47 such as, for example, the type of sensor utilized in an optical mouse, is configured to optically detect movement of the cleaning system relative to the surface 19 as shown in FIG. 21 as will be understood by one skilled in the art. Optical flow sensors 47 output data identifying the relative change in position from the previous position. This information is provided to controller 4 of the cleaning system to establish the distance traveled from the starting point. In the embodiment described here, the optics have been optimized for use in the underwater environment and configured to allow a greater standoff distance to the surface. The output of the sensor is an accurate measurement of translation on the two-dimensional plane of the ship's hull. By using two optical flow sensors, one on each side of the HullBUG, the translation information can be used to estimate rotation as well. The precise translation and rotation measurements allow for extended excursions of the HullBUG on the ship's hull or other underwater surface while maintaining accurate knowledge of the present position.

A pressure sensor 48 may also be implemented and used to estimate the submerged depth of the cleaning system as shown in FIG. 21. The depth information is provided to controller 4, which uses the provided data to make the cleaning system navigate along a series of parallel paths 49 with each path following an isobar as shown in FIG. 22. In order to follow an isobar in an environment where surface waves can cause motions in the navigation, the measurement of the gravity vector using the accelerometer described below can be used as an inner control loop with the depth controller as an outer control loop; a technique understood by one skilled in the art. In addition to the pressure sensor and corresponding depth information allowing isobar following mission paths, the depth information can be used as a condition for the completion of a transit leg 50 along a navigation path that traverses a change in depth.

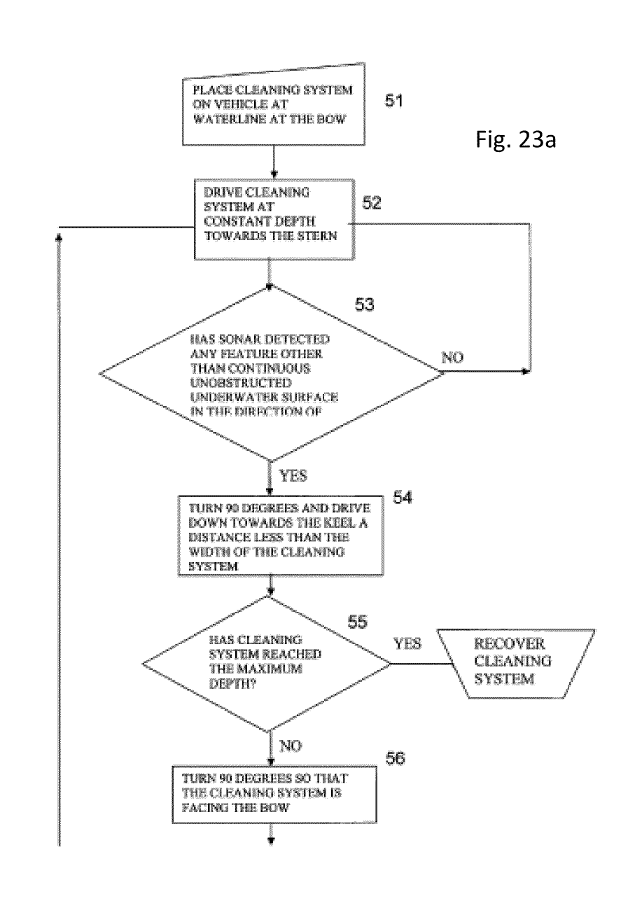

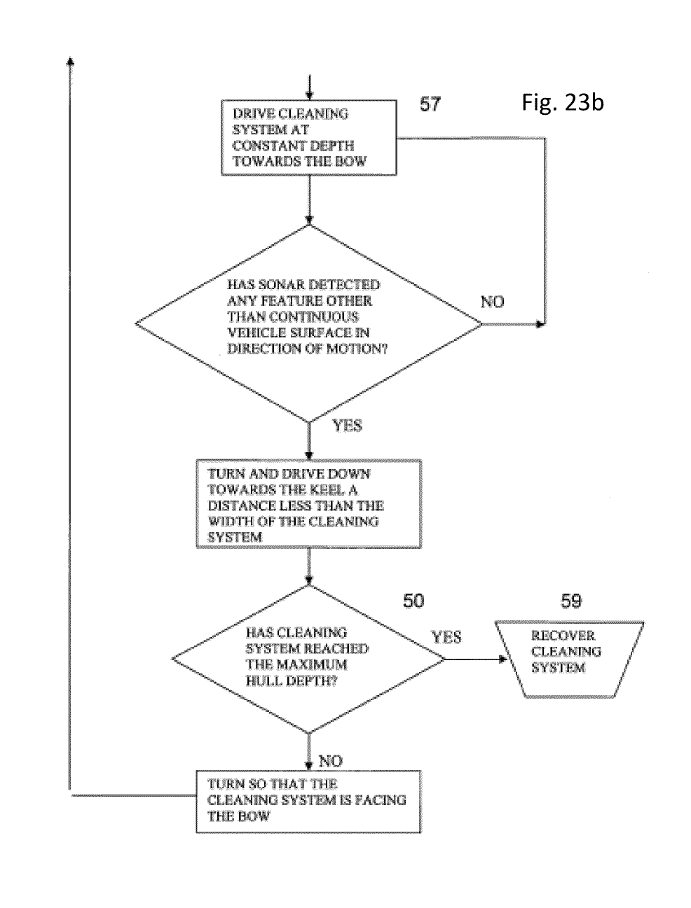

A flow chart for the control logic of controller 4 using the sensor information, such as from the pressure sensor described previously and a SONAR, to develop a complete navigation strategy for cleaning an entire ship is shown in FIG. 23. The mission begins with the operator placing the vehicle on the side of the ship at the waterline near the bow 51. The HullBUG has a pressure sensor that enables a change in ambient pressure when the HullBUG is below the surface of the water to be detected. Additionally, the pressure sensors provide signals to controller 4 that engages the attraction device and activates the propulsion system such that the HullBUG cleaning system is propelled along the underwater surface at a constant depth towards the stern of the ship 52. The HullBUG cleaning system continues along the isobar until the SONAR detects a feature that will prevent the continuation of the current leg of the mission such as the stern of the ship at block 53. Once the feature is detected, the HullBUG turns down towards the keel and drives a distance less than the width of the HullBUG chassis 54. The HullBUG cleaning system uses a depth measurement to check that the current depth is still less than the maximum depth of the side of the ship 55, which may be known a-priori and stored in a computer readable storage medium such as, for example, main memory 106 and/or secondary memory 108. Alternatively, the mission may be terminated using an accelerometer to measure the pitch and roll of the cleaning system and then use the change in the pitch/roll as the cleaning system reaches the turn of the bilge of a ship. The HullBUG then turns back in the direction of the bow 56 and proceeds at a depth greater than the depth of the previous leg and parallel to the previous leg 57. The HullBUG cleaning system continues in the same fashion with parallel mission legs 49 until the depth as measured by the pressure sensor indicates that the maximum safe depth has been reached 50 at which point the HullBUG cleaning system turns and drives up back to the waterline and waits for recovery 59 or relocates to the beginning of another section of the underwater surface to begin cleaning.

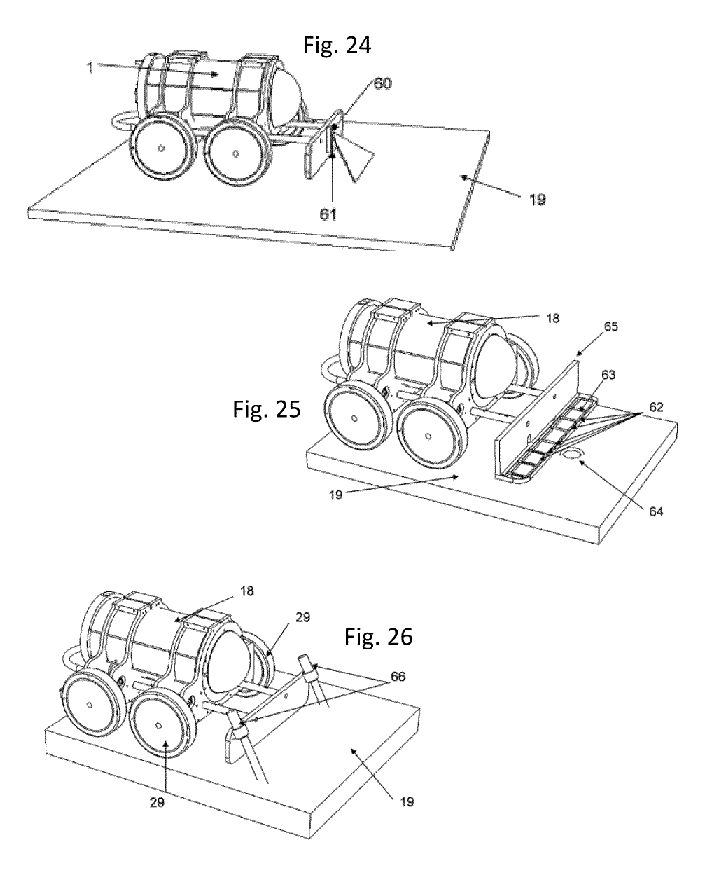

In some embodiments, a structured laser light (“SLL”) sensor, which includes a laser line generator 60 and an imaging sensor 61, is mounted on the periphery of the cleaning system and used to detect any feature in the path of the HullBUG cleaning system as illustrated in FIG. 24. In operation, laser line generator 60 projects a line onto the surface of the hull 19. The laser is at a shallow angle to the surface such that irregularities from a smooth straight surface will cause the line to become irregular or discontinuous. The miniature video sensor 61 images the line and signal processing techniques are used to determine the extent of the surface irregularity. The acquired surface information is analyzed by the controller 4, which makes a decision to go over or around the discovered irregularity. The SLL enables the HullBUG cleaning system to navigate around obstacles without actually having to come in contact with the obstacles. A series of the SLL sensors mounted across the front of the cleaning system and allow the optical path to be very short and results in successful operation when operating in very low visibility waters.

One or more flex sensors 62 may be provided on or around chassis 18 of the sensing system for detecting inlets and outlets 64 on the underwater surface 19 into which or out of which fluid flows as shown in FIG. 25. Flex sensors 62 provide a signal proportional to the bend direction and bend radius of the sensor to controller 4. Flex sensors 62 may be embedded in a flexible rubber matrix 63 mounted on the front 65 of the cleaning system. As the HullBUG cleaning system moves toward an inlet or outlet 64, any fluid flow causes the cantilevered rubber 63 to flex and bend the flex sensors 62. The signal from the flex sensors 62 is transmitted to controller 4, which adjusts the direction in which the cleaning system is propelled by propulsion system 3 to avoid chassis 18 passing over the inlet or outlet 64.

Navigation on the hull of the ship is further enhanced with the use of Miniature Acoustic Ranging Sonar (“MARS”) 66 as shown in FIG. 26. The MARS is an underwater acoustic ranging SONAR that provides an accurate distance to the hull surface 19. Since MARS is acoustic in nature, the measurement is not dependent on the clarity of the water. By placing 2 or more of these sensors 66 in the front of the vehicle 65, objects or features on the hull can be detected and the vehicle can maneuver around them. These sensors provide a remote sensing so that the vehicle can stop before actual contact is made. With just a single sensor in front of each wheel 29, any holes on the surface can be detected before the wheel can fall in. For example, the SONAR sensors periodically transmit a beam of acoustic energy away from chassis 18 and receive a reflected signal (echo), which undergoes signal processing to determine the presence of and/or distance to a wall and/or cliff condition, i.e., features found on ships and liquid storage tanks such as walls, keels and rudders. The SONAR sensors output data to controller 4 including a distance to any such wall or cliff condition. If the distance to a wall or cliff condition is below predetermined threshold, controller 4 modifies the direction in which the cleaning system is propelled to avoid the wall and/or cliff condition.

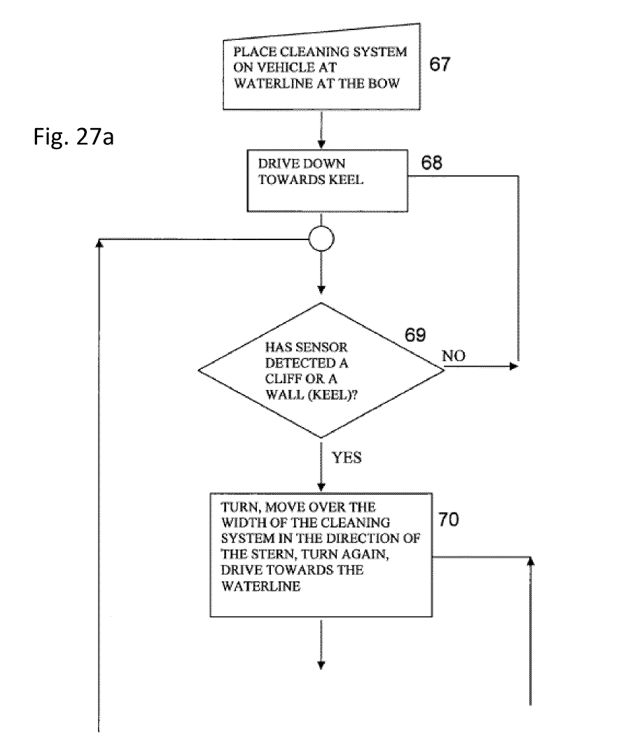

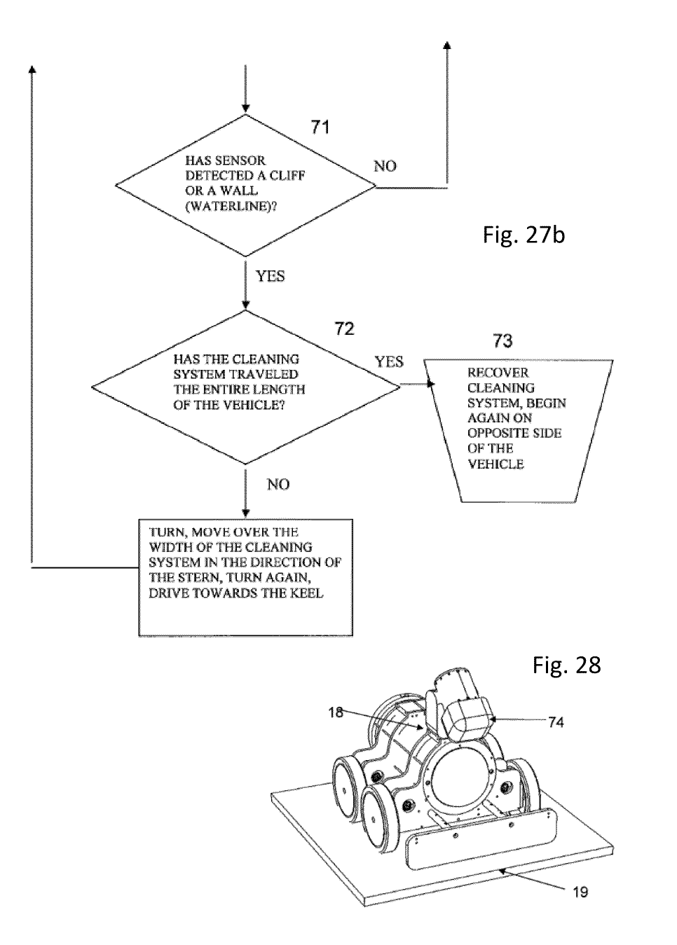

The control system in the vehicle can use sensor information such as from the MARS sensor described previously to develop a complete navigation strategy for cleaning an entire ship as shown in FIG. 27. As shown in FIG. 27, the mission begins with the operator placing the vehicle on the side of the ship at the waterline near the bow 67. The cleaning system has a three-axis accelerometer within the chassis 18 so the HullBUG can determine what direction is up and what direction is down relative to gravity. An example of a commercially available accelerometer is a model MMA726Q accelerometer available from Freescale Semiconductor of Chandler, Ariz. The HullBUG drives down from the waterline 68 until a cliff or wall condition 69 by the MARS sensors 66. The vehicle then turns 90 degrees (or another angle as will be understood by one skilled in the art) towards the stern and drives a distance of something less than the width of the HullBUG and then turns back towards the waterline 70. The HullBUG cleaning system then drives up towards the waterline where the free surface of the water appears as a wall to an acoustic beam 71. The HullBUG continues in the same fashion with parallel mission legs until the stern is seen as a cliff condition and the mission is completed 72 at which point the HullBUG cleaning system turns and drives up back to the waterline and waits for recovery 73. The HullBUG can then be placed on the opposite side of the ship and the procedure repeated resulting in the cleaning of the entire ship.

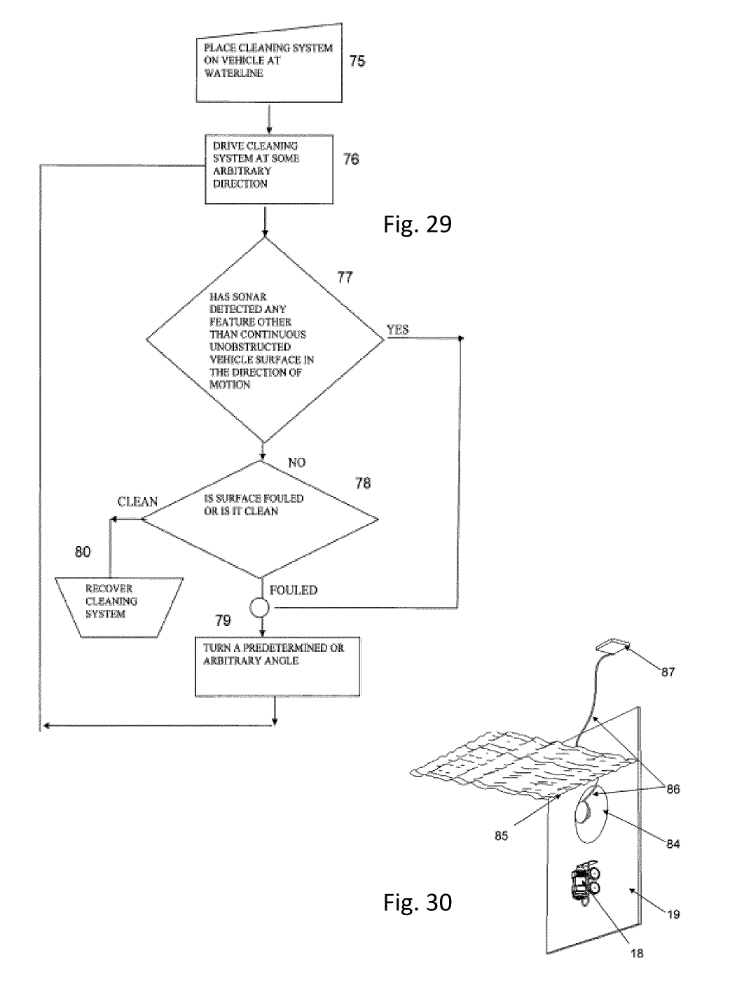

In addition to the features described above, additional and somewhat more geometrically complex features such as anodes and cavities may be disposed on surface 19. An imaging or bathymetric SONAR 74 may be implemented and used to detect these features and the previously described features as shown in FIG. 28. FIG. 29 is a flow chart illustrating the logic that the controller will use to implement the SONAR sensor and biofilm sensor. As shown in FIG. 29, the mission begins with the operator placing the cleaning system on the side of the ship at the waterline 75. The HullBUG drives in a direction (in some embodiments and arbitrary direction) 76 until the SONAR detects some obstruction to the progress of the mission leg 77. The cleaning system then turns at an arbitrary or fixed angle 79 and proceeds until once again the SONAR detects some obstruction 77. The HullBUG continues in the same fashion repeatedly until the biofilm sensor 43 no longer detects the presence of a biofilm 38 on the hull surface 19 and the mission is completed 72 at which point the HullBUG turns and drives up back to the waterline and waits for recovery 80 or the start of a new section.

The use of an intelligent camera system 81 may assist in maintaining the positional accuracy as the HullBUG cleaning system navigates along an underwater surface. A camera system 81 or a SONAR system 74 enables feature recognition and thereby allows the absolute position to be updated. In this manner, positional accuracy can be maintained through periodic corrections. Software stored in a computer readable storage medium, such as, for example, main memory 106 and/or secondary memory 108 in communication with processor 102 of controller 4, may be used to identify such features. One example of such software is ImageGraphics Video available from Dynamic Ventures of Cupertino, Calif.

The feature data will be useful even if the visibility is less than a foot. For example, in some embodiments, when the flex sensors 62 hit some feature 82 and cause the vehicle to stop, the camera may be less than four inches away from the feature and able to identify the feature. With the feature recognized, the HullBUG cleaning system can accurately update its position on the surface. Where visibility is on the order of a few feet or greater, features such as weld lines 83 in the hull can be used as a navigation grid on the hull of the ship. Other features that may augment navigation through the use of the vision system include anodes, intakes, bilge keels, and masker belts.

When used in an autonomous mode, the HullBUG cleaning system can be used with a replenishment station 84 attached to the hull surface 19 slightly below the waterline 85 as shown in FIG. 30. This replenishment station is tethered 86 to the surface control station 87 and allows bi-directional data communication with the HullBUG along with the ability to recharge on-board energy storage 5. The HullBUG cleaning system can return to the station using an acoustic sensor system 88 that is commercially available for such applications. One example of such an acoustic sensor system is a DPR-275 receiver and UPB-350 pinger, which are both available from RJE International of Irvine, Calif.

One skilled in the art will understand that the cleaning system described above may be implemented with some or all of the sensor and cleaning systems to provide a high degree of positional accuracy of the cleaning system on the surface. Additionally, the sensor systems enable the HullBUG cleaning system to detect and avoid potential obstacles along the surface as well as enable the cleaning system to detect biofouling on the surface. Other sensors including, but not limited to, yaw rate sensors, an odometer, and Doppler sensor may also be included in the HullBUG cleaning system.

In addition to be used to clean the underwater surface, the HullBUG may also be used to inspect the underwater surface and determine if it needs to be cleaned. For example, the HullBUG may periodically navigate the underwater surface based on a predetermined schedule to determine if cleaning is necessary. The predetermined schedule may be based on fouling pressure, ambient water temperature, available sunlight, surface coating type, amount of time a ship or surface to be cleaned is mobile, speed of ship, speed of surrounding water currents, and the like. The article “The use of proactive in-water grooming to improve the performance of ship hull antifouling coatings”, by Tribou et al., the entirety of which is herein incorporated by reference, describes how such factors may be taken into account to determine a cleaning schedule. If cleaning is necessary, then the HullBUG may clean the surface as described above. If the HullBUG determines that cleaning is not necessary, then it may return to its replenishment station and schedule a follow-up inspection after a certain time interval, e.g., in another few hours, days, weeks, etc. When the HullBUG performs its follow-up inspection, it will determine if cleaning is necessary by measuring a fouling level, which may be based on a chlorophyll level detected by the sensors described above. If cleaning is necessary, then the HullBUG cleaning system may update its time between scheduled inspection/cleaning times.

The systems and methods disclosed herein may be at least partially embodied in the form of computer-implemented processes and apparatus for practicing those processes. The methods described herein may also be at least partially embodied in the form of computer program code embodied in tangible machine readable storage media, such as RAMs, ROMs, CD-ROMs, DVD-ROMs, BD-ROMs, hard disk drives, flash memories, or any other machine-readable storage medium, wherein, when the computer program code is loaded into and executed by a computer, the computer becomes an apparatus for practicing the method. When implemented on a general-purpose processor, the computer program code segments configure the processor to create specific logic circuits. The disclosed systems and methods may alternatively be at least partially embodied in a digital signal processor formed of application specific integrated circuits (“ASICs”) for performing a method according to the principles described herein.

Although the system and method have been described in terms of exemplary embodiments, the invention is not limited to the embodiments presented as examples, and is defined by the appended claims, which claims are to be construed broadly to include other variants and embodiments of the system and method, which may be made by those skilled in the art without departing from the invention as disclosed and claimed.

What is claimed is:

1. An apparatus for traversing ferrous surfaces, comprising:
a transport element arranged to move over a ferrous surface;
a chassis carried on the transport element whereby the chassis is movable over the ferrous surface on the transport element;
at least one magnet coupled to one of the transport element and the chassis;
a controllable mechanism for moving the magnet toward and away from the ferrous surface, up to a relatively smaller gap distance at which the magnet exerts an attractive force between the magnet and the ferrous surface, and up to a relatively larger gap distance at which the attractive force is reduced.

2. The apparatus of claim 1, wherein the transport element comprises at least one wheel having a rotation axis, wherein the magnet is disposed on a radius around the rotation axis, and wherein the controllable mechanism places a flux path of the magnet at a radius that is perpendicular to the ferrous surface for obtaining the smaller gap distance, and at a radius that is oblique to perpendicular for obtaining the relatively larger gap distance.

3. The apparatus of claim 2, wherein the controllable mechanism is configured to place the flux path of the magnet at one of plural angular positions for selecting among plural gap distances.

4. The apparatus of claim 3, wherein at least one of the plural angular positions establishes a gap at which the attractive force is at least sufficient to cause the apparatus to cling to the ferrous surface, and at one other of the plural angular positions establishes a gap at which the attractive force is less than a level at which the apparatus clings to the ferrous surface.

5. The apparatus of claim 4, wherein the controllable mechanism comprising a crank arm that is movable by at least one of a solenoid, a motor and a manual action.

6. The apparatus of claim 3, further comprising a flux concentrator magnetically coupled to the magnet, and wherein the controllable mechanism orients the flux concentrator at said one of the plural angular positions.

7. The apparatus of claim 3, wherein the magnet comprises a permanent magnet.

8. The apparatus of claim 1, wherein the transport element comprises at least two cylinders arranged as one of wheels and rollers, and the magnet comprises permanent magnets controllably placed in each of the at least two cylinders.

9. The apparatus of claim 8, wherein the at least two cylinders comprise at least one chassis wheel bearing against the ferrous surface as one of a drive wheel, idle wheel and steering wheel.

10. The apparatus of claim 9, wherein the at least two cylinders comprise a wheel bearing against the ferrous surface, and a roller wheel operatively coupled to one of a belt and a track bearing against the ferrous surface.

11. The apparatus of claim 3, wherein the wheel comprises a hollow wheel with a magnetically non-permeable radially outer layer, wherein the magnet is mounted on a mounting structure carried coaxially with a rotation axis of the wheel, and wherein the gap is varied by rotation of the mounting structure toward and away from the ferrous surface.

12. The apparatus of claim 1, further comprising a propulsion system for propelling the chassis across the ferrous surface; at least one sensor and at least one actuator carried on the chassis; and a controller coupled to said at least one sensor and at least one actuator for input and output respectively, wherein the controller is programmed to maneuver and operate the propulsion system and the actuator in response to at least one condition detected by the sensor.

13. The apparatus of claim 12, wherein the propulsion system includes said transport element, wherein the transport element comprises one of a wheel and a roller, and wherein the controller is configured to operate the controllable mechanism for moving the magnet toward and away from the ferrous surface.

14. The apparatus of claim 12, wherein the sensor is configured to sense a parameter representing fouling of a hull underwater and the actuator comprises a tool for cleaning the hull.

15. The apparatus of claim 12, further comprising at least one fluid impeller arranged to produce one of thrust and suction contributing to one of maneuvering the apparatus and cleaning the hull.

16. The apparatus of claim 12, further comprising a source of illumination on the chassis and wherein the sensor is responsive to chlorophyll present in a biofilm in response to the biofilm being illuminated.
